(19) United States
(12) Patent Application Publication
(10) Pub. No.: US 2020/0055397 A1
(43) Pub. Date: Feb. 20, 2020

(54) USER INTERFACE AND METHOD FOR THE INPUT AND OUTPUT OF INFORMATION IN A VEHICLE

(71) Applicant: VISTEON GLOBAL TECHNOLOGIES, INC., Van Buren Township, MI (US)

(72) Inventors: Yanning Zhao, Monheim (DE); Alexander Van Laack, Aachen (DE)

(73) Assignee: VISTEON GLOBAL TECHNOLOGIES, INC., Van Buren Township, MI (US)

(21) Appl. No.: 16/347,504

(22) PCT Filed: Nov. 3, 2017
(86) PCT No.: PCT/EP2017/078146

§ 371 Date: May 3, 2019

(30) Foreign Application Priority Data
Nov. 3, 2016 (DE) 102016120999.6

(51) Int. Cl. B60K 35/00; G06F 3/01

(52) U.S. Cl. CPC B60K 35/00; G06F 3/017; B60K 2370/146; B60K 2370/334; B60K 2370/186; B60K 2370/1531; B60K 2370/21; B60K 2370/1529

(57) ABSTRACT

A user interface and a method for the inputting and outputting of information in the vehicle includes an image generation unit which generates a projected image. A means for gesture recognition is arranged as a means for detecting an input, and that a means for view detection and following is arranged such that the recognition of the viewing direction and an association of the viewing direction of the driver with an area in the vehicle is carried out. Information about this area is generated in the viewing direction in the form of a projected image and is displayed floating over the area. Recognition of gestures of the driver is carried out. Upon a coincidence of a position of a hand of the driver, detected by the gesture recognition, with the projected image or a component of the projected image, a signal is generated by the central control unit and outputted.

### CROSS REFERENCE TO RELATED APPLICATIONS

This application claims the benefit of PCT Patent Application No. PCT/EP2017/078146 filed on Nov. 3, 2017, entitled “USER INTERFACE AND METHOD FOR THE INPUT AND OUTPUT OF INFORMATION IN A VEHICLE,” which is incorporated by reference in its entirety in this disclosure.

### TECHNICAL FIELD

The invention relates to a user interface which comprises an arrangement for the generation of images, the displaying of images and information and a means for detecting a gesture of a user, wherein the arrangement for the generation of images and the means for detecting a gesture are connected to a central control unit.

The invention also relates to a method for the input and output of information in a vehicle, in which information is outputted by an arrangement for the generation of images and in which inputs of a user are detected by a means for the detection of a gesture, wherein a controlling of the output of information and of the detection of inputs is controlled by a central control unit.

The invention describes possibilities for controlling a machine such as, for example, a vehicle by instructions of a user or driver via a user interface. This can be in the case of a vehicle any technical apparatus for locomotion, preferably motorized land vehicles, air vehicles or water vehicles such as, for example, a motor vehicle, truck, rail vehicle, airplane or a boat.

### BACKGROUND

A so-called user interface, also designated as an operator interface or in English “Human Machine Interface” (HMI), determines the way how a human can communicate with a machine and vice versa. The user interface determines how a human transmits his instructions to the machine, how the machine reacts to the user inputs and in which form the machine makes its replies available. Such user interfaces must be adapted to the requirements and capabilities of a human and are usually ergonomically designed.

Modern motor vehicles comprise as a rule a plurality of user interfaces. This includes means for the inputting of instructions or commands such as, for example, a pedal, steering wheel, switching levers and/or blinking levers, switches or buttons. Alternatively, inputs can also take place via input elements or control elements which are shown on a display.

User interfaces also comprise suitable means for the optical, acoustical or haptic perception or reply such as displays for speed, range, travel settings or transmission settings, radio programs, sound settings and many others.

The number of possible operating movements and/or instructions of a vehicle driver as well as those necessary for the controlling of a vehicle are continually increasing. In addition to the functions necessary for guiding a vehicle such as controlling the direction and the speed of the vehicle, there are more and more possibilities for controlling additional functions. Such additional functions concern, for example, systems such as an air conditioning system, a sound system, a navigation system, and settings for possible running gear functions and/or transmission functions.

The plurality of switches, buttons, keys, input displays and other operating elements available to the vehicle driver as well as the plurality of displays for information, suggestions and/or warning signals in the cockpit of a motor vehicle place a greater and greater stress on the attention of the vehicle driver. At the same time they increase the danger of distracting the driver and therefore raise the safety risk when driving a motor vehicle.

In order to reduce this safety risk, many vehicle manufacturers offer integrated electronic displays with a menu-driven command control which combine a broad palette of functions in a single user interface.

This solution has the disadvantage that a large number of pieces of information and possibilities of selection have to be displayed for the driver simultaneously in the view field of the driver or in a suitably placed display, which again increases the danger of distracting the driver.

In addition to showing the information and the possibilities of selection, means for inputting or selecting by the driver must also be made available in the display and which can be operated by the driver during driving. Even these means constitute a potential danger for safety.

Since a certain amount of hand-eye coordination of the driver is required for the operating of very different vehicle systems, the concentration of the driver on the driving of the vehicle is at least partially adversely affected.

It is also known from the prior art that a reduction of the information to be shown can be achieved in that only the information or possibilities of selection with a certain connection are displayed. These so-called pieces of context-sensitive information or possibilities of selection are, for example, limited to a single system such as a navigation system.

It is also known from the prior art to project information for a user, for example a car driver or a pilot, into his field of view by a head-up display. A head-up display, also abbreviated as a HUD, is understood as a display system in which the user can retain the position of his head in his direction of view substantially in the original alignment in order to view the displayed information. Such head-up displays generally comprise their own image-generating unit which makes the information to be shown available in the form of an image, comprise an optical module which makes possible the course of the beam inside the head-up display to an exit opening and is also designated as a mirror lens, as well as comprises a projection surface for showing the image to be generated. The optical module conducts the image onto the projection surface which is constructed as a reflecting, light-permeable pane and is also designated as a combiner. In a special case the windshield pane suitable to this end is used as protection surface. The vehicle driver sees the reflected information of the image-generating unit and simultaneously the actual surroundings behind the windshield pane. Therefore, the attention of a vehicle driver, for example when driving a motor vehicle, is directed onto what is happening in front of the vehicle while he can detect the information projected into the field of view.

An arrangement for detecting the viewing is known from US 2014/0292665 which uses sensors which can detect the direction of the view of the driver and can identify the component viewed by the driver. This publication does not disclose possibility of making information available with a reduced density of information or in a manner in which the selected component is marked with color or text.

US 2010/0014711 discloses a system for illuminating a vehicle cabin on the basis of the head position of the driver. However, this publication discloses that the illumination is provided for an improving the visibility conditions for the driver. Therefore, no information can be brought to individually selected areas for display.

### SUMMARY

The invention has the problem of indicating a user interface and a method for the inputting and outputting of information in a vehicle with which a simplified operation of vehicle systems, a reduction of the information density and an improvement of the concentration of the driver on the driving of the vehicle are achieved.

The problem is solved by a subject matter with the features according to Claim 1 of the independent claims. Further developments are indicated in the dependent Claims 2 to 6.

The invention makes a user unit (HMI) available which interacts with the driver of a vehicle as a function of the situation and requires only a small amount of space for the showing of information on a display or in the vehicle cabin.

To this end a detection of the direction of viewing and a following of the view of the user or of the driver is provided by a means for the detection and following of the view. At least one area inside the vehicle is recognized to which the view of the driver is directed by the evaluation of the direction of the view or of the following of the view. It can also be provided to this end that it is recognized whether the driver is observing structural groups or systems inside the vehicle or whether his view is directed outward into the vehicle surroundings.

If the driver's view is directed onto structural groups or systems inside the vehicle, an association of the direction of the view with a structural group or a system such as an air conditioning system, a sound system, an informational display, a steering wheel, a rear view mirror, a covering or lid of a storage compartment, a control arrangement for a transmission or something else takes place.

This makes it possible to display to the driver the information which belongs to or is possible for his direction of view by a suitable projection or representation. This can preferably take place by a laser projection which is suitable for representing geometric shapes as well as signs such as written characters. Such a representation can also take place in different colors.

It is provided that information or possibilities of selection are made available by a laser projection over an area recognized in the interior of the vehicle such as, for example, a service element or a closed storage chamber. The user interface according to the invention is designed in such a manner that an operating action of the driver such as, for example, a selection of one of the selection possibilities shown by a means suitable for recognizing a movement or gesture of the driver is recognized and made available in the form of a piece of information from a corresponding, central control unit.

This control unit converts the information made available and brings about a reaction associated with the selection of the driver such as, for example a turning on or off of the corresponding function or the opening of a lid of the storage space. Known means can be used for such a gesture recognition such as, for example a camera attached in the vehicle and a corresponding evaluation unit.

It is provided that a spatial light modulator (SLM) is used to generate the laser projection. For example, technologies such as liquid crystal on silicone (LcoS), digital light processing (DLP) or micro-electromechanical systems MEMS can be used for the generation of images. The generation of three-dimensional views is especially advantageous. Views in two or three dimensions as well as in color are provided.

The problem is also solved by a method with the features according to Claim 7 of the independent claims. Further developments are indicated in the dependent Claims 8 to 13.

The invention realizes a recognition of a direction of a driver's view and an association of this known direction of view to an area in the interior of the vehicle, wherein the areas are associated with structural groups or systems in the vehicle. Such an area can be, for example, an air outlet opening of an air conditioning system, a sound system or its loudspeakers, an informational display, a steering wheel, a rear view mirror, a covering or lid of a storage compartment, a control arrangement for the transmission and others.

If the driver's view is directed to one of these areas, then information about the selected area in the driver's direction of viewing is generated in the form of a projected image and represented over the area. The projected image can be a two-dimensional or three-dimensional representation. A representation in one or more colors is possible.

If the driver moves his hand or his finger in the direction of or toward this projected image, this gesture is detected. A gesture recognition can take place in such a manner that not only a coincidence of the direction of the gesture or of the position of a finger with the projected image is detected but also the exact position of the finger inside the projected image, which can comprise several components. If, for example, a coinciding of the direction or of the position of the finger with the position of one of these buttons is recognized, then this button is recognized as selected. A central control and evaluation unit generates a signal which characterizes the selection of this button. The selected function such as, for example, the turning on of the sound system or of an air conditioning system can be converted controlled by this signal.

It is provided that the projected image can comprise one or more components. Therefore, for example, one or more buttons can be made available in the projected image for an alternative selection. The content of the projected image or of its components can comprise, for example, text characters, special signs, symbols, plane or spatial geometric figures in different colors or images.

The invention provides that the interior of the vehicle is subdivided into areas. Such areas are associated with structural groups or systems in the vehicle such as, for example, an air conditioning system, a sound system, an informational display, a steering wheel, a rear view mirror, a covering or lid of a storage container, a control arrangement for a transmission and others. In the case of an air conditioning system the area can be formed, for example, by the zone of one or more air outlet openings. In the case of a lid of a storage space the zone is determined by the shape of the lid. In the case of a sound system the shape can be determined by an associated display and/or by the loudspeakers arranged in the dashboard and/or in the doors.

It is also provided that the projected image is shown in such a manner that that it is shown from the viewpoint of the driver over a certain area, i.e., for example above the air outlet openings of the air conditioning system. The border of the projected image is brought in coincidence with the boundaries of the area. The boundaries of an area can be formed, for example, by a frame which runs around an air outlet opening of an air conditioning system. The frame can also run along the border of a rearview mirror, of an informational display or of other systems or structural groups.

The projected image contains information, for example, in the form of text characters or symbols which represent the possible functions which can be selected by the driver for the corresponding area. Here, so-called context-related information for being shown in the projected image are used only in conjunction with this area. Therefore, for example, for the area of the air outlet openings the functions of turning on or off as well as selection possibilities regarding a temperature or a fan stage can be shown. For the area of a rearview mirror this can be a selection possibility for dimming, which can also be offered in several stages. Furthermore, the context-related information can be checked for its plausibility prior to being shown in the projected image. Therefore, a possibility of turning on the system is not offered in the selection if the system is already turned on. If a CD is being played, for example, in a sound system, only functions for operating the CD player and no selection possibilities for selecting a transmitter are displayed.

It is especially advantageous for recognizing the gestures of the driver to use technologies in which a measuring of runtime is carried out by a time-of-flight (ToF) camera. Alternatively, for example, a method which operates with infrared light or capacitively can be used.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

Other details, features and advantages of embodiments of the invention result from the following description of exemplary embodiments with reference made to the attached drawings. In the drawings:

FIG. 1 shows an exemplary course for the method for inputting and outputting information in a vehicle,

FIG. 2 shows a first embodiment of the user interface (HMI) according to the invention,

FIG. 3 shows an exemplary use of the invention with several views, and

FIG. 4 shows another exemplary use of the invention with the showing of a warning signal.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

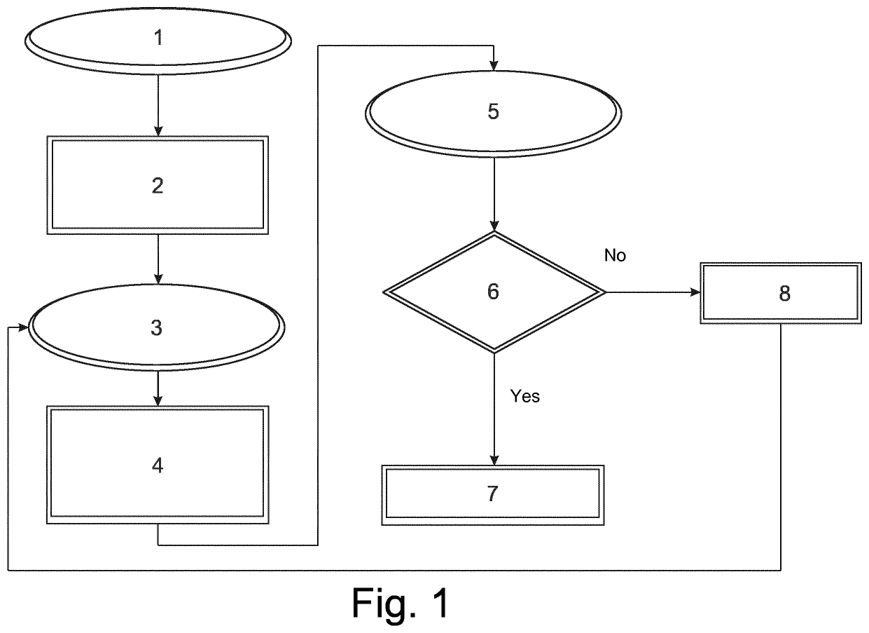

FIG. 1 shows an exemplary course for the method for inputting and outputting information in a vehicle. The method course begins in step 1 with a detection and following of the view of the driver. Based on this detected information, on the one hand the area is determined in step 2 which is currently being viewed by the driver, such as, for example, an air outlet opening of an air conditioning system in the area of a vehicle dashboard. On the other hand, a selection of the display information or possibilities of selection is carried out which are possible in conjunction with this viewed area of the air conditioning system. Here, the current operating states of the vehicle systems are included in the selection. If the air conditioning system is turned on, for example, then the possibility of turning it on is not displayed.

In step 3 the generation of a projected image 9 is started, for example, by a laser-based image generating unit 10. The displaying of the projected image 9 on the area being viewed by the driver 11 takes place in step 4. In the example a colored surface with the inscription “Engage” or “Turn on” can be displayed over the air outlet opening of the air conditioning system. Green can be selected as color for the projected surface in order to signal to the driver that the displayed selection is possible.

The selection of the colors can take place using a customary characterization of dangerous states with a red color, suggestion messages with a yellow color and the available options in a green color, which characterization is also widely used in vehicles. There is no limitation to this selection of colors—if, for example, the optical system of the displays in the dashboard uses a blue design, a coordination or adaptation to the existing color tone can advantageously improve the total impression.

In addition to colored surfaces in different geometrical variations such as, for example, a rectangle, square, circle, ellipse, trapezoid or a triangle, any symbols and characters can be displayed. A display of an image is also possible. Three-dimensional displays can also be generated.

It is provided that the display of the projected image 9 over the area being viewed by the driver 11 takes place at the moment at which the driver 11 directs his view into this area. Alternatively, the display of the projected image 9 can be started with a set time delay in order to exclude undesired displays which distract the driver 11, for example, for the case that the driver 11 allows his view to move over the dashboard in order to see into the right outside mirror.

The display of the projected image 9 on a selected area can take place until the driver 11 has made an input or selection. Alternatively, the display can be ended without an input or selection having taken place if the driver 11 changes his direction of view and looks, for example, again in the direction of travel through the windshield 12 at his surroundings 13. It is advantageous that the ending of the display takes place in a time-delayed manner since in this manner the projected image 9 remains over the selected area if the driver 11 briefly changes his direction of view and subsequently returns back to the selected area.

If, for example, a colored surface with the inscription “turn on” is shown over the air outlet opening of the air conditioning system, a recognition of the gesture of the movements of the driver 11 takes place in step 5 by the means for gesture recognition 14. If the driver 11 moves his hand, for example, to the surface shown in green with the inscription “turn on” in order to touch it, so to say, with his hand 15 or with a finger of the hand 15, this gesture is recognized by a means for gesture recognition 16 and the corresponding signal is generated for the central control and evaluation unit. This control and evaluation unit comprises information about the projected image 9 with its position and its selection possibilities as well as about the information regarding the recognized gesture and is therefore capable in step 6 to carry out a check that checks whether the gesture can be correctly associated with the projected image 9 or a component of the projected image 9 such as a button or a key. Therefore a check is made in the example whether the driver 11 has touched, so to say, the surface shown in green with the inscription “turn on” with his hand 15.

A check is made here for a coinciding of the positions of the projected image 9 in the recognized position of the hand 15 or of the fingers of the driver 11. Even in this case a coinciding of the positions cannot result in a generation of a corresponding signal which characterizes a coincidence until after the passage of a waiting time.

If such a coincidence is recognized, the selected function is activated in step 7. In the example shown the turning on of the air conditioning system of the vehicle takes place. For the case that no or no clear coincidence can be recognized, a corresponding error message is generated in step 8, outputted in step 3 to the image generation unit 10 and displayed in step 4. Such an error message can be, for example, a red surface with the inscription “mistake” or “error”.

As has already been shown in the example, an adaptation to a language of a driver or his preference, for example, for a color or shape can be carried out.

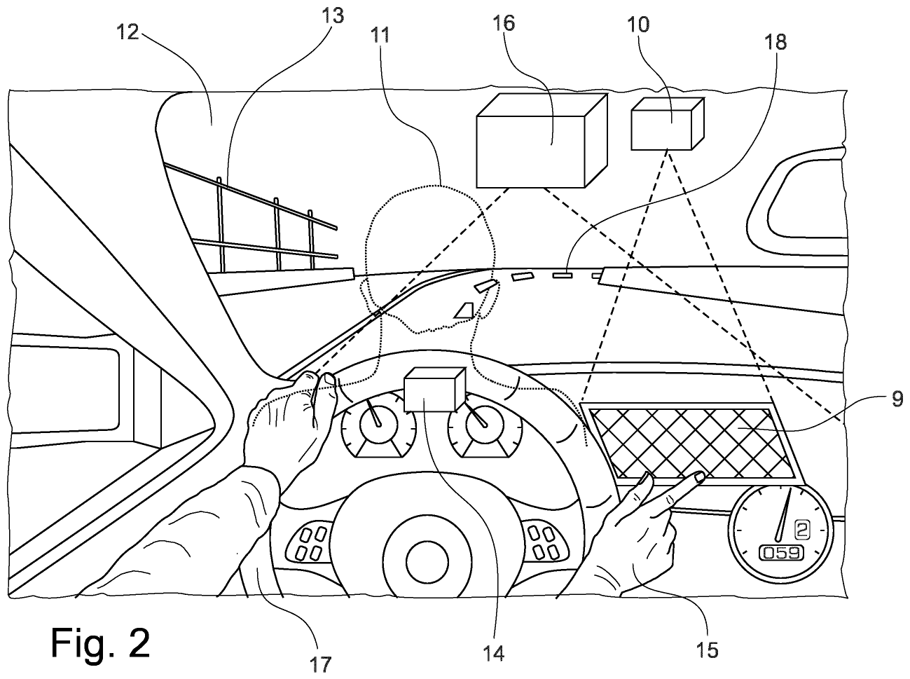

FIG. 2 shows an exemplary usage of the invention with a projection or display on a recognized vehicle area for controlling the air conditioning system. A means for detecting and following the view 14 is arranged in an area of the dashboard under the windshield 12 in the vicinity of the steering wheel 17. This means 14 is positioned in such a manner that it can readily recognize the driver 11. Alternatively, the means for detecting and following 14 can be arranged in the upper area of the windshield 12 or on the left adjacent to the windshield 12 in the A column of the vehicle.

After having recognized the direction of the view of the driver 11, who is only indicated in FIG. 2, onto an area of an air outlet opening of an air conditioning system in the middle of the dashboard, a display of a projected image 9 which shows, for example, a green surface with an inscription “engage” or “turn on” takes place above this area. For this display, for example, an image generation unit 10 is arranged in a central area above the windshield 12.

For example, a means for gesture recognition 16 is arranged adjacent to the image generation unit 10 and can readily detect the area of the driver 11. The driver 11 can turn on the air conditioning system by a suitable gesture in which he brings the position of his hand 15 or of a finger of this case and 15 into coincidence with the position of the projected image 9, as is shown in FIG. 2. After the air conditioning system has been turned on, which can take place by the central control and evaluation unit, the display of the projected image ends.

In this example the air conditioning system was turned off when the means for detecting and following the view 14 detected the area of the air outlet opening of the air conditioning system. Therefore, only the context-related possibility of turning on the air conditioning system was displayed by the projected image 9. In another case in which the air conditioning system is already turned on, the possibility of turning it off is displayed by the projected image 9. This method makes it possible to minimally affect the distraction of the driver 11. Therefore, he can optimally concentrate on what is happening on the stretch course 18 on the street in front of him and on the surroundings 13.

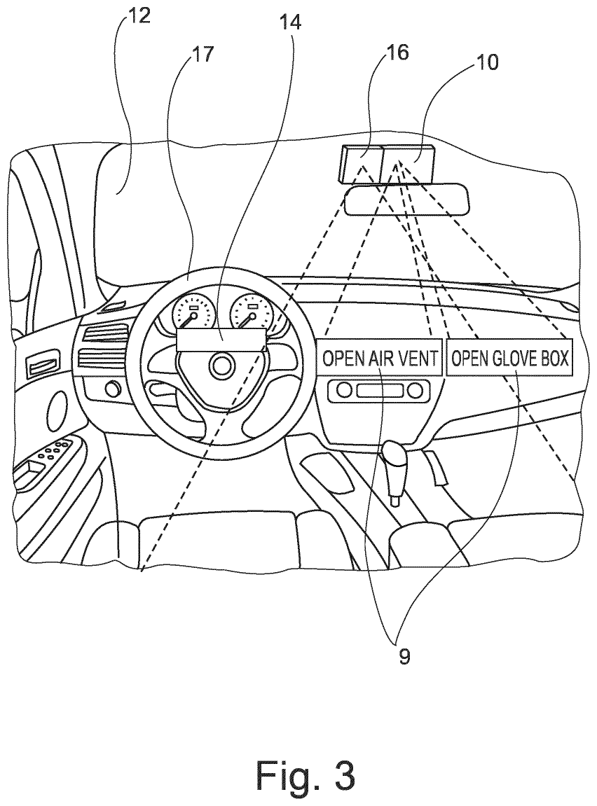

FIG. 3 shows an exemplary usage of the invention with a display of two projected images 9. In this case a direction of view of the driver 11, who is not shown in FIG. 3, onto the right area of the vehicle windshield was recognized by the means for view detection and following 14, which is shown in FIG. 3 in the area of the steering wheel 17, for example, integrated in an area in the windshield. In this case two selection possibilities are offered to the driver 11 by the display of two projected images 9.

The first selection possibility, which is shown by the image generation unit 10 above an area of an air outlet opening of an air conditioning system, shows a surface, green, for example, with the inscription “engage”, “turn on” or “open air vent”. The second selection possibility, which is shown in an area above a lid of a glove box, shows a green surface with the inscription “open glove box”.

In this case the driver 11 can either turn the air conditioning system on or open the lid of the glove box by a suitable gesture which is detected by a means for gesture recognition 16. An alternative embodiment can provide that the driver 11 selects both selection possibilities and then turns on the air conditioning system and also subsequently opens the lid of the glove box, wherein the sequence of his selection can be any one. There is no limitation to the two alternatives shown in this example.

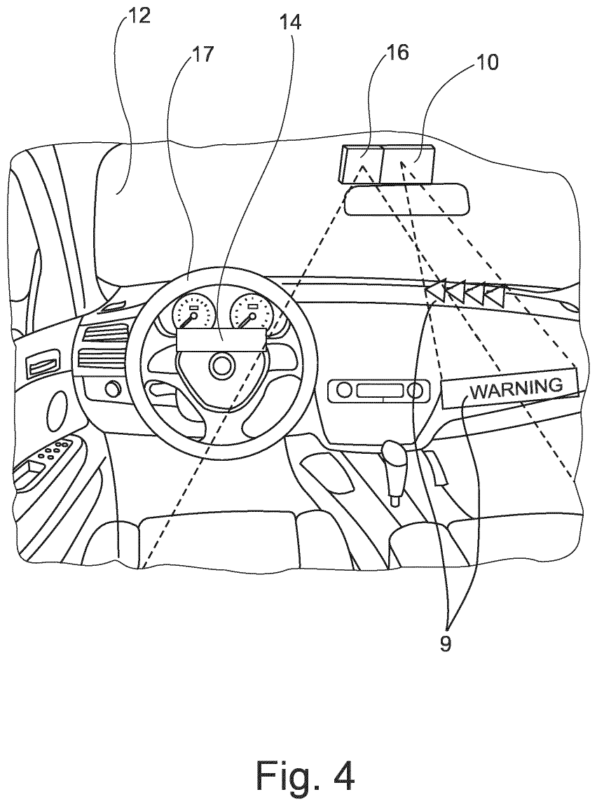

FIG. 4 shows another exemplary usage of the invention with a display of an error message or warning message. If a gesture of the driver 11 cannot be clearly associated with a projected image 9 because, for example, the gesture of the driver 11 was very imprecise, this state can be indicated by a display of a projected image 9 with an error message, for example, with the inscription “mistake” or “error” by the means for gesture recognition 16 in cooperation with the central control and evaluation unit.

As an alternative, a warning message can be displayed in the visible range of the driver 11 with the inscription “warning!” in the form of a projected image 9 and in a red color if a critical vehicle state was recognized. This state can occur, for example, if the look of the driver 11 is directed away from the traffic in front of the vehicle for a rather long time onto an area in the vehicle and this is recognized by the means for view detection and following 14.

Alternatively or additionally, information about too close an interval from a vehicle in front or the recognition of a curve in the road can be used to initiate a warning message.

In addition to the inscription in the projected image 9, in the case of a recognized left curve a display of an arrow facing left as in FIG. 4 or some other suitable symbol can be used which warns the driver 11 already in the direction of view facing away from the traffic and prepares him for the event to be expected. In FIG. 4 this additional indication is displayed by four left-pointing triangles. In addition to a color display, for example in red in order to indicate a critical state, the projected image 9 can also be shown blinking.

### LIST OF REFERENCE NUMERALS

1 start view detection and following
2 determination of the context-based, direction-dependent information
3 start of the laser projection
4 display of the projected image
5 gesture recognition
6 check gesture selection correct
7 activation of the selected function
8 generation of an error message
9 projected image
10 image generation unit
11 driver
12 windshield
13 surroundings
14 means for view detection and following, gesture recognition
15 hand
16 means for gesture recognition
17 steering wheel
18 stretch course

The detailed description and the drawings or figures are supportive and descriptive of the disclosure, but the scope of the disclosure is defined solely by the claims. While other embodiments for carrying out the claimed teachings have been described in detail, various alternative designs and embodiments exist for practicing the disclosure defined in the appended claims.

1. A user interface which comprises an arrangement for the generation of images, the displaying of images and information and a means for detecting a gesture of a user, wherein the arrangement for the generation of images and the means for detecting a gesture are connected to a central control unit, characterized in that an image generating unit which generates a projected image is arranged as an arrangement for the generation of images, that a means for gesture recognition is arranged as a means for the detection of an input, and that a means for view detection and following is arranged.

2. The user interface according to claim 1, characterized in that the image generation unit, the means for gesture recognition and the means for view detection and following are arranged in the interior of a vehicle.

3. The user interface according to claim 1, characterized in that the image generation unit is a laser projector.

4. The user interface according to claim 1, characterized in that the means for gesture recognition is a 3-D camera, an infrared camera or a time-of-flight (ToF) camera.

5. The user interface according to claim 1, characterized in that the means for view detection and following is a 3-D camera.

6. The user interface according to claim 1, characterized in that a heads-up display (HUD) unit is arranged as another means for displaying information in the vehicle.

7. A method for the input and output of information in a vehicle, in which information is outputted by an arrangement for the generation of images and in which inputs of a user are detected by a means for the detection of a gesture, wherein a controlling of the output of information and of the detection of inputs is controlled by a central control unit, characterized in that a recognition of a viewing direction of a driver takes place, that an association of the viewing direction of the driver with an area in the vehicle is carried out, that information is generated to this area in the viewing direction of the driver in the form of a projected image and displayed over the area, that a recognition of gestures of the driver is carried out and that upon a coincidence of a position of a hand of the driver detected by the gesture recognition with the projected image or a component of the projected image a signal is generated and outputted by the central control unit.

8. The method according to claim 7, characterized in that the projected image or its components contains text characters, special signs, symbols, plane or spatial geometric figures in different colors or images.

9. The method according to claim 7, characterized in that an area in the vehicle is associated with a structural group or a system in the vehicle.

10. The method according to claim 7, characterized in that the projected image is displayed adapted to the shape of the area so that the border of the projected image coincides with the boundaries of the area.

11. The method according to claim 7, characterized in that the information displayed in the viewing direction of the driver in the projected image is context-related information.

12. The method according to claim 7, characterized in that the information in the projected image displayed in the viewing direction of the driver is checked for plausibility before the display by an image generation unit.

13. The method according to claim 7, characterized in that the gesture recognition is carried out by a means for gesture recognition by a run time method or by an infrared method.
